(19) United States
(12) Patent Application Publication
(10) Pub. No.: US 2010/0138044 A1
(43) Pub. Date: Jun. 3, 2010

(54) SYSTEM AND METHOD FOR FIXED FOCUS LONG FORMAT DIGITAL RADIOGRAPHY

(75) Inventors: Hanns-Ingo Maack, Nordested (DE); Ulrich Neitzel, Hamburg (DE)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 12/063,237

(22) PCT Filed: Aug. 1, 2006
(86) PCT No.: PCT/IB06/52620

§ 371 Date: Feb. 8, 2008

(30) Foreign Application Priority Data
Aug. 8, 2005 (EP) 05107271.8

(51) Int. Cl. G01T 1/161; G05B 15/02

(52) U.S. Cl. 700/275; 250/393

(57) ABSTRACT

An X-ray imaging system comprising a motorised X-ray tube located at a fixed focus position (12) relative to an object (14) to be imaged, and a motorised detector (18) for detecting the intensity distribution of radiation transmitted through the object. A control system (22) is provided for calculating two or more angles (Ot1) from which the object (14) should be exposed to radiation in order to cover the entire exposure field (H) occupied by the object (14) and for causing the X-ray tube to be rotated around the fixed focus position (12) so as to expose the object (14) to radiation from each of the respective angles (Ot1). The movement of the detector (18) is also performed automatically so as to correspond with the exposure angles so as to create two or more respective images of respective regions of the object (14) which can be subsequently stitched together to create a complete image thereof.

The invention relates generally to long format digital radiography and, more particularly, to a system and method for performing fixed focus long format radiographic examinations.

Full spine and full leg radiographic examinations, for example, may be required for orthopedic applications such as the evaluation of scoliosis or deformations of the lower extremities. Such examinations require images that are longer than the length of normal sized radiographic films. It is possible to overcome this problem by using an extra long, non-standard film exposed from quite a large distance, but this approach is expensive and inconvenient.

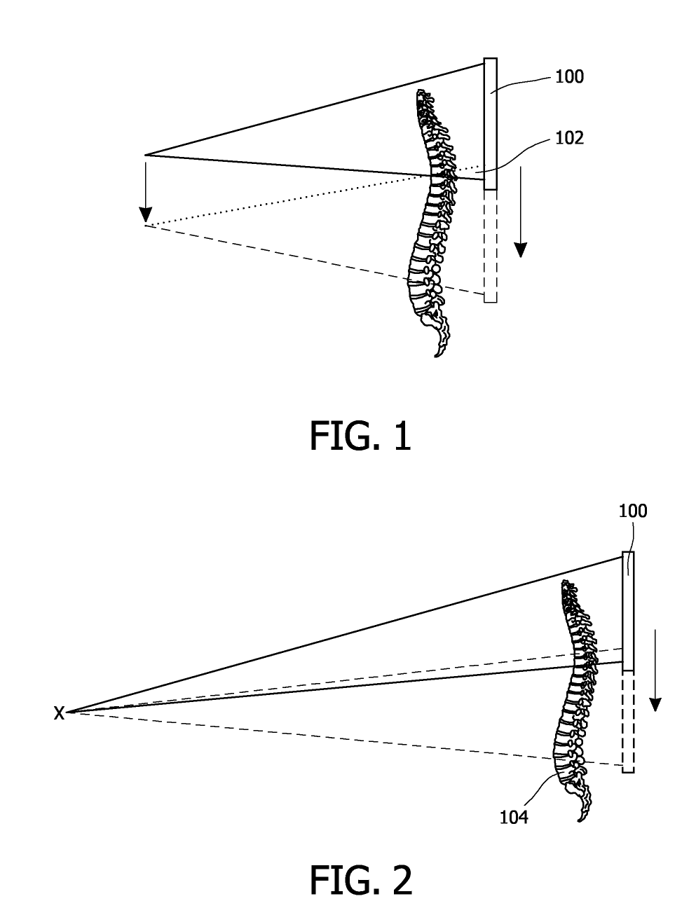

In an alternative solution, several normal sized films may be used to obtain two or three sub-images of different parts of the leg or spine, which sub-images can then be stitched together using digital image processing techniques to create an image of the full spine or leg. Two different techniques are known in this regard, namely “parallel shift” and “fixed focus position”. Referring to FIG. 1 of the drawings, in the parallel shift method, the X-ray tube (focal spot) and detector 100 are shifted together, in parallel, by a distance slightly smaller than the image length (so that adjacent images overlap slightly). The tube or focal spot and detector remain centred, and the degree of collimation and tube angle need not be adjusted. Although this solution is technically the easiest to achieve, it suffers from the drawback that seamless stitching of the images is impossible because of the different projection angles in the overlap region 102, and the error increases with increasing field length and decreasing focal distance.

EP-A-1484016 describes an X-ray system for obtaining a view of a patient that is larger than a field of view of the X-ray detector. The exposure field covering the area to be imaged is manually input by the user. An X-ray source exposes the entire area of the patient to be imaged whilst the detector is moved in a stepwise manner to collect sub-images of sections of the area to be imaged. These sub-images are then stitched together to create a composite image of the entire area.

Referring to FIG. 2 of the drawings, in a simplified fixed focus position method, the focus X is fixed, the X-ray tube is manually rotated around the focus X, the detector 100 moves along the spine 104 to slightly overlapping positions, and images of the spine 104 are acquired one after the other. The images are then stitched together afterwards using a known image processing technique. It would obviously be desirable, both for convenience and accuracy, for the rotation of the X-ray tube around the focus to be automated and for optimal detector movement to be determined accordingly.

It is therefore an object of the present invention to provide a system and method for performing long format radiography by means of the fixed focus position method, wherein rotation of the X-ray tube around the focus and corresponding detector positioning is automated in an optimal manner

In accordance with a first aspect of the present invention, there is provided an imaging system for acquiring an image of an object, the system comprising radiation generating means located at a fixed focus position relative to said object and a detector having an active region for detecting the intensity distribution of radiation transmitted through said object and generating an image representative thereof, wherein said object occupies an exposure field larger than the active region of said detector, the system further comprising means for calculating two or more angles from which to expose said object to radiation corresponding to two or more respective regions of said exposure field, means for automatically rotating said radiation generating means around said fixed focus position so as to successively expose said object to radiation from said respective two or more angles, means for automatically moving said detector to successively detect the intensity distribution of radiation transmitted through said object at said two or more regions so as to generate two or more respective images thereof.

Also in accordance with the first aspect of the present invention, there is provided a method for acquiring an image of an object, the method comprising using radiation generating means to expose said object to radiation from a fixed focus position relative thereto, using a detector having an active region to detect the intensity distribution of radiation transmitted through said object, and generating an image representative thereof, wherein said object occupies an exposure field larger than the active region of said detector, the method further comprising calculating two or more angles from which to expose said object to radiation corresponding to two or more respective regions of said exposure field, automatically rotating said radiation generating means around said fixed focus position so as to successively expose said object to radiation from said two or more respective angles, automatically moving said detector relative to said object to detect the intensity of radiation transmitted therethrough at said two or more regions of the exposure field during exposure of said object to radiation in said respective regions so as create two or more respective images representative thereof.

Preferably, image processing means are provided for subsequently stitching together said two or more images to create a composite image of said object.

Thus, the first aspect of the present invention provides a system and method for automatically rotating the radiation generation means (e.g. an X-ray tube) around a fixed focus position so as to successively expose regions of the object within a larger exposure field to radiation, and automatically moving the detector (e.g. a flat panel X-ray detector) correspondingly so as to detect the intensity distribution of radiation transmitted through the object at those regions and generate images thereof which can be subsequently stitched together to create a complete image of the object.

Benefits afforded by the present invention include:

Long objects can be imaged using a standard smaller film, for example, objects of up to say 120 cm can be imaged using a standard 43 cm detector;

Optimal geometric projection can be achieved;

An easy and intuitive workflow is provided;

Simple and convenient positioning procedure is provided by automated detector and tube positioning.

In a preferred embodiment, collimating means may be provided between said radiation generating means and said object for collimating said radiation. Means are preferably provided for automatically adjusting said collimating means to correspond with the angulation of said radiation generating means. Movement of the detector relative to the object is preferably linear. The collimating means may comprise a symmetrical or non-symmetrical opening through which said radiation passes to said object.

The number of images required to create an image of the entire object is obviously dependent on the size of the active region of the detector and the size of the exposure field occupied by the object. Preferably, edge portions of images of said object generated in respect of adjacent regions thereof overlap. In a preferred embodiment, the exposure field occupied by the object is defined in a step preceding the imaging process. In one exemplary embodiment, the exposure field may be defined by exposing the object to a visible light beam from said fixed focus position and adjusting the collimating means such that the exposure field of the light beam covers the object to be imaged.

In fact, in accordance with a second aspect of the present invention, there is provided a method for defining the exposure field of an imaging system comprising radiation generating means for exposing an object to be imaged to radiation from a fixed focus position relative thereto, a detector having an active region for detecting the intensity distribution of radiation transmitted through said object, means for generating an image representative thereof, and collimating means for collimating said radiation prior to exposure of said object thereto, wherein said object occupies an exposure field larger than the active region of said detector, the method comprising generating a visible light beam at said fixed focus position, using said collimating means to collimate said light beam and generate a light field, placing said object in said light field, and adjusting said collimating means so as to adjust the size of said light field in accordance with said object, said light field defining said exposure field of said imaging system.

Preferably, generation of the imaging radiation is inhibited during the above-mentioned process for defining the exposure field. Beneficially, the method may further comprise the step of adjusting the height of the source of the visible light beam so as to adjust the position of the light field relative to the object.

These and other aspects of the present invention will be apparent from, and elucidated with reference to the embodiments described herein.

Embodiments of the present invention will now be described by way of examples only and with reference to the accompanying drawings, in which:

FIG. 1 is a schematic diagram illustrating the underlying principle of the parallel shift long image format radiography method;

FIG. 2 is a schematic diagram illustrating the underlying principle of the fixed focus position long image format radiography method;

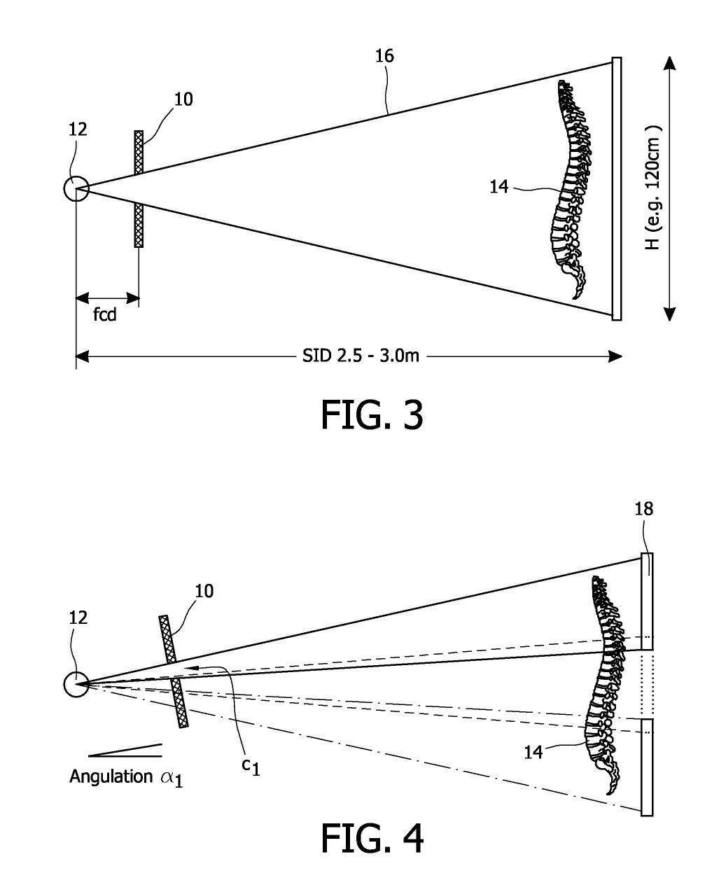

FIG. 3 is a schematic diagram illustrating key features of a method according to an exemplary embodiment of the second aspect of the present invention for defining the exposure field of an imaging system;

FIG. 4 is a schematic diagram illustrating the key features of a method according to an exemplary embodiment of the first aspect of the present invention for acquiring an image of an object; and

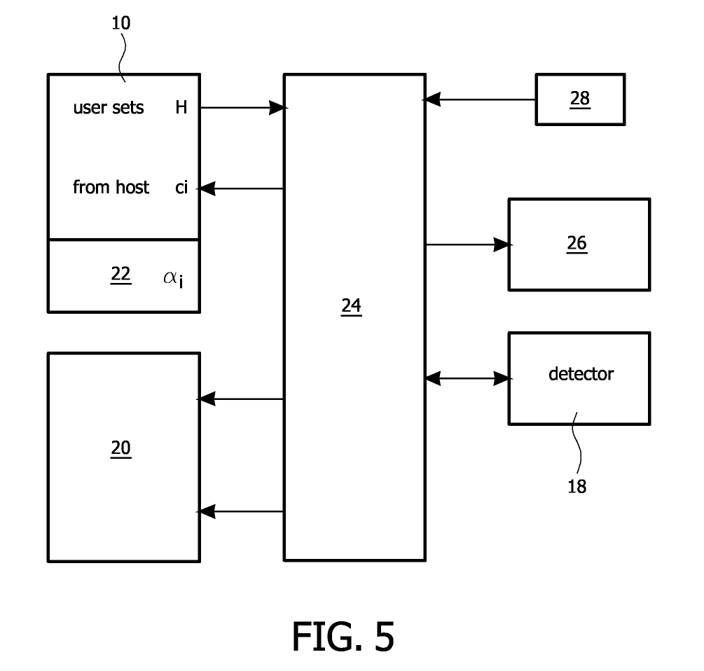

FIG. 5 is a schematic block diagram illustrating key components of an imaging system according to an exemplary embodiment of the first aspect of the present invention.

Thus, the present invention is concerned generally with the provision of a system and method for performing long image format digital radiography using a flat panel detector of limited size by exposing the subject to be imaged in a step-by-step manner (e.g. by obtaining three overlapping images within an exposure field H), whilst keeping the position of the X-ray focus constant with respect to the patient (typically within a distance of >250 cm). In order to expose the detector in all of the desired positions, the X-ray tube is required to be angulated and the detector is required to be moved accordingly, and it is an object of the present invention to automate these functions in an optimal manner It will be appreciated that collimation of the X-ray beam needs to be adapted according to the angulation of the X-ray tube.

The abbreviations used in the following detailed description of exemplary embodiments of the present invention are given in Table 1 below.

TABLE 1

| | |
|---|---|
| αᵢ | Tube angulation angle in image i |
| cᵢ | Collimator opening for image i |
| CR | Computed Radiography; the cassettes with photostimulable |
| | phosphors to be read out by a reader |
| dety | Detector useful dimension in y direction, for |
| | example 43 cm |
| DR | Source image Distance between focus and detector |
| fcd | Focus collimator distance |
| H | Height of the total image |
| hᵢ | Detector position in image i |
| N | Number of images required |
| overlap | Overlap between images to cope with the ramp in the beam |
| | intensity profile and mechanical tolerences |
| SID | Direct radiography, abbreviation for integrated flat panel |
| | detectors |
| yᵢ | Subimage length on detector |
| atan, cos | Arcus tangens, cosinus |
| C_upper_i | Position of upper lead edge in non-symmetric collimator |
| | in image i |
| C_lower_i | Position of upper lead edge in non-symmetric collimator |
| | in image I |

Referring to FIG. 3 of the drawings, in a first step, the large exposure field H is defined using light field adjustment of a collimator 10 located between the focus 12 and the object 14 to be imaged. During this collimation procedure, X-ray generation is inhibited. A visible light source at the focus 12 is used to accurately collimate the entire anatomical region to be imaged and define the required exposure field H by adjusting the tube height and collimator size so that the visible light beam 16 covers the anatomical region to be imaged. Once the correct anatomical region has been collimated in this manner, the user presses an “end of collimation” button (not shown) so as to enable the imaging procedure to be commenced.

Referring to FIG. 4 of the drawings, in the following example, the exposure field H is 120 cm and this field is to be imaged by acquiring three adjacent images using a 43 cm detector 18. In order to expose the detector 18 in all three positions, the X-ray tube at the focus 12 must be angulated accordingly. Referring additionally to FIG. 5, a complete imaging process in accordance with an exemplary embodiment of the present invention will now be described in detail. A system according to this exemplary embodiment comprises an X-ray control unit 20 in respect of the X-ray tube, for disabling X-ray generation during the interactive collimation procedure described above to define the large exposure field H and for releasing an X-ray beam during the imaging process, a tube rotation unit 22 in association with the collimator 10, for automatically rotating the X-ray tube, and a host computer 24.

Also provided are detector height control unit 26 and a SID detection unit 28.

N=2: h₁=(y₁−overlap)/2; h₂=not necessary; h₃=−h₁

N=3: h₁=y₁−overlap; h₂=0; h₃=−h₁

### Tube Angulation

N=3: α₁=a tan [(y₁−overlap)/SID]

α₂=−α₁

N=2: α₁=a tan [(y₁−overlap)/(2*SID)]

α₂=−α₁

N=1 is no real stitching, no tube angulation required

### Collimator Opening

cᵢ=cos(α₁)*y₁*fcd/SID

c₂=y₁*fcd/SID

c₃=c₁

### Prepare Image 1 of 3:

Set tube angulation, Collimator opening, Detector position to values α₁,c₁ and h₁
Release X-ray; read out and store the image
Make images 2 and 3 accordingly
The images are stored individually in the host PC
Additionally a stitched image can be generated and displayed by state of the art software procedures

In case of a collimator with a non-symmetrical opening, some parameters can be set differentially:

### Tube Angulation

No tube angulation required

### Collimator Opening

N=3: C_upper_{—}=H/2; C_lower_{—}1=H/2−y₁

C_upper_{—}2=y₂/2: C_lower_{—}2=−y₂/2;

C_upper_{—}3=−(H/2−y₃); C_lower_{—}3=−H/2

N=2: C_upper_{—}1=H/2; C_lower_{—}1=H/2−y₁

C_upper_{—}2=−(H/2−y₂); C_lower_{—}2=−H/2

N=1 is no real stitching, C_upper_{—}1 H/2; C_lower_{—}1=−H/2

For security reasons, the user may be required to press during the whole procedure. It will be appreciated that exposure settings can be re-programmed as required for each image. For example, they may be adjusted to reduce the amount of potential scattering of X-rays. However, the present invention is not particularly concerned with this element of digital radiography and no further detail is provided herein in this regard.

Thus, in order to automatically perform the required angulation of the X-ray tube and corresponding detector movements, wherein the collimation is adapted to the angulation, the following equations may be used to calculate the various parameters:

yi=H/N+(N−1)*(overlap) for all i

α₁=a tan [(y₁−overlap)/SID]; α₁=−α₁

c₁=cos(α₁)*y₁*fcd/SID

The tube angulation α needs to be set with an accuracy of 0.2° to achieve an error in the detector plane of less than 1 cm at an SID of 3 m. Another key idea presented herein is to define the large exposure field H using the light field adjustment of the collimator in a step preceding the imaging process. The subsequently acquired images are later stitched together using a known software procedure.

It should be noted that the above-mentioned embodiments illustrate rather than limit the invention, and that those skilled in the art will be capable of designing many alternative embodiments without departing from the scope of the invention as defined by the appended claims. In the claims, any reference signs placed in parentheses shall not be construed as limiting the claims. The word “comprising” and “comprises”, and the like, does not exclude the presence of elements or steps other than those listed in any claim or the specification as a whole. The singular reference of an element does not exclude the plural reference of such elements and vice-versa. The invention may be implemented by means of hardware comprising several distinct elements, and by means of a suitably programmed computer. In a device claim enumerating several means, several of these means may be embodied by one and the same item of hardware. The mere fact that certain measures are recited in mutually different dependent claims does not indicate that a combination of these measures cannot be used to advantage.

1. An imaging system for acquiring an image of an object (14), the system comprising radiation generating means located at a fixed focus position (12) relative to said object (14) and a detector (18) having an active region for detecting the intensity distribution of radiation transmitted through said object (14) and generating an image representative thereof, wherein said object (14) occupies an exposure field (H) larger than the active region of said detector (18), the system further comprising means (22) for calculating two or more angles (αᵢ) from which to expose said object (14) to radiation corresponding to two or more respective regions (hᵢ) of said exposure field (H), means for automatically rotating said radiation generating means around said fixed focus position (12) so as to successively expose said object (14) to radiation from said respective two or more angles (αᵢ), means (26) for automatically moving said detector (18) to successively detect the intensity distribution of radiation transmitted through said object (14) at said two or more regions so as to generate two or more respective images thereof.

2. A system according to claim 1, further comprising image processing means (24) for stitching together said two or more images to create a composite image of said object (14).

3. A system according to claim 1, further comprising collimating means (10) between said radiation generating means and said object (14) for collimating said radiation.

4. A system according to claim 3, further comprising means for adjusting said collimating means (10) to correspond with the angulation of said radiation generating means.

5. A system according to claim 1, wherein movement of the detector (18) relative to the object (14) is linear.

6. A system according to claim 3, wherein said collimating means (10) comprises a symmetrical or non-symmetrical opening through which said radiation passes to said object 14).

7. A system according to claim 1, wherein edge portions of images of said object (14) generated in respect of adjacent regions thereof overlap.

8. A system according to claim 1, wherein the exposure field (H) occupied by the object (14) is defined in a step preceding the image acquisition.

9. A system according to claim 8, wherein said exposure field (H) is defined by exposing the object (14) to a visible light beam (16) from said fixed focus position (12) and adjusting collimating means (10) provided between said fixed focus position (12) and said object (14).

10. A method for acquiring an image of an object, the method comprising using radiation generating means to expose said object to radiation from a fixed focus position relative thereto, using a detector having an active region to detect the intensity distribution of radiation transmitted through said object, and generating an image representative thereof, wherein said object occupies an exposure field larger than the active region of said detector, the method further comprising calculating two or more angles from which to expose said object to radiation corresponding to two or more respective regions of said exposure field, automatically rotating said radiation generating means around said fixed focus position so as to successively expose said object to radiation from said two or more respective angles, automatically moving said detector relative to said object to detect the intensity of radiation transmitted therethrough at said two or more regions of the exposure field during exposure of said object to radiation in said respective regions so as to create two or more respective images representative thereof.

11. A control system (22) for controlling motive means associated with the radiation generating means of a system according to claim 1, said control system (22) comprising means for calculating two or more angles (αᵢ) from which to expose said object (14) to radiation corresponding to said two or more regions (hᵢ) of said exposure field (H), and means for causing said motive means to rotate said radiation generating means around said fixed focus position (12) so as to successively expose said object (14) to radiation from said respective two or more angles (αᵢ).

12. A control system (22) according to claim 11, further comprising means (26) for determining a desired position (hᵢ) of said detector (18) relative to said object (14) to correspond with each of said two or more angles (αᵢ), and means for causing motive means associated with said detector (18) to move said detector (18) so as to detect the intensity distribution of radiation transmitted through said object (14) during exposure thereof to radiation from each of said two or more angles (αᵢ).
